(19) United States
(12) Patent Application Publication
(10) Pub. No.: US 2013/0340980 A1
(43) Pub. Date: Dec. 26, 2013

(54) IMPROVEMENTS IN OR RELATING TO GAS COOLERS FOR INTERNAL COMBUSTION ENGINES

(71) Applicant: Martin Dirker, West Chicago, IL (US)

(72) Inventor: Martin Dirker, West Chicago, IL (US)

(73) Assignee: PERKINS ENGINES COMPANY LIMITED, Peterborough, Cambridgeshire (GB)

(21) Appl. No.: 13/989,384

(22) PCT Filed: Nov. 16, 2011
(86) PCT No.: PCT/EP2011/070262

§ 371 Date: Sep. 11, 2013

(30) Foreign Application Priority Data
Dec. 10, 2010 (EP) 10194603.6

(51) Int. Cl. F02M 25/07

(52) U.S. Cl. CPC F02M 25/07
USPC 165/109.1; 165/172

(57) ABSTRACT

An exhaust gas cooler for internal combustion engines which leads to improvements in the reliability and durability of such exhaust gas coolers. The cooler comprises a housing (1) comprising a top wall (2), a bottom wall (3) and first and second side walls (4, 5) extending longitudinally from a first end to a second end to define a void space. Wherein a plurality of cooler tubes (10′) extend longitudinally in said housing (1) and are arranged in a column from towards the bottom wall (3) to towards the top wall (2). Wherein the plane of each cooler tube (10′) is canted relative to the first and second side walls of the housing (1).

### FIELD

The present disclosure relates to improvements in or relating to exhaust gas coolers for internal combustion engines.

### BACKGROUND

Exhaust Gas Recirculation (EGR) is a known technique for use in internal combustion engines (petrol or diesel) wherein a portion of an engine's exhaust gas is recirculated back to the engine cylinders. EGR may be used to reduce emissions of oxides of nitrogen including NO and NO₂. It can be desirable when operating an EGR system to cool the hot exhaust gases before the gases are returned to the engine cylinders. In order to achieve this it is known to use an EGR cooler wherein the exhaust gases are passed through a cooler wherein the gases are transmitted through cooler tubes that are in heat transfer contact with a cooling medium, such as water.

It is known to mount cooler tubes vertically within an EGR cooler housing. The cooler tubes within the housing are vertically orientated and arrayed in two rows with an upper row comprising four tubes and a lower row comprising three tubes.

The present applicant has discovered that a high failure rate of the known geometry can occur, in particular due to high stresses developed at the junction between the cooler tubes and transverse baffles. In particular, stress concentrations in the baffle at the junctions between the cooler tube mounting points can lead to premature failure.

### DISCLOSURE

According to the present disclosure there is provided an exhaust gas cooler comprising:
a housing comprising a top wall, a bottom wall and first and second side walls extending longitudinally from a first end to a second end to define a void space;
a plurality of cooler tubes extending longitudinally in said housing and arranged in a column from towards the bottom wall to towards the top wall, wherein the plane of each cooler tube is canted relative to the first and second side walls of the housing.

### BRIEF DESCRIPTION OF THE DRAWINGS

FIG. 1 is a perspective view of an exhaust gas cooler according to the present disclosure with ancillary pipes connected thereto;

FIG. 2 is a schematic view of cooler tubes of the exhaust gas cooler of FIG. 1 with other components omitted for clarity;

FIG. 3 is a perspective view of an exhaust gas cooler according to the present disclosure;

FIG. 4 is a perspective view of the exhaust gas cooler of FIG. 3 with an end cap removed;

FIG. 5 is a schematic view of a baffle of the exhaust gas cooler of FIG. 3;

FIG. 6 is a schematic view of another baffle according to the present disclosure; and

FIG. 7 is a cross-sectional view of a part of the exhaust gas cooler of FIG. 3.

### DETAILED DESCRIPTION

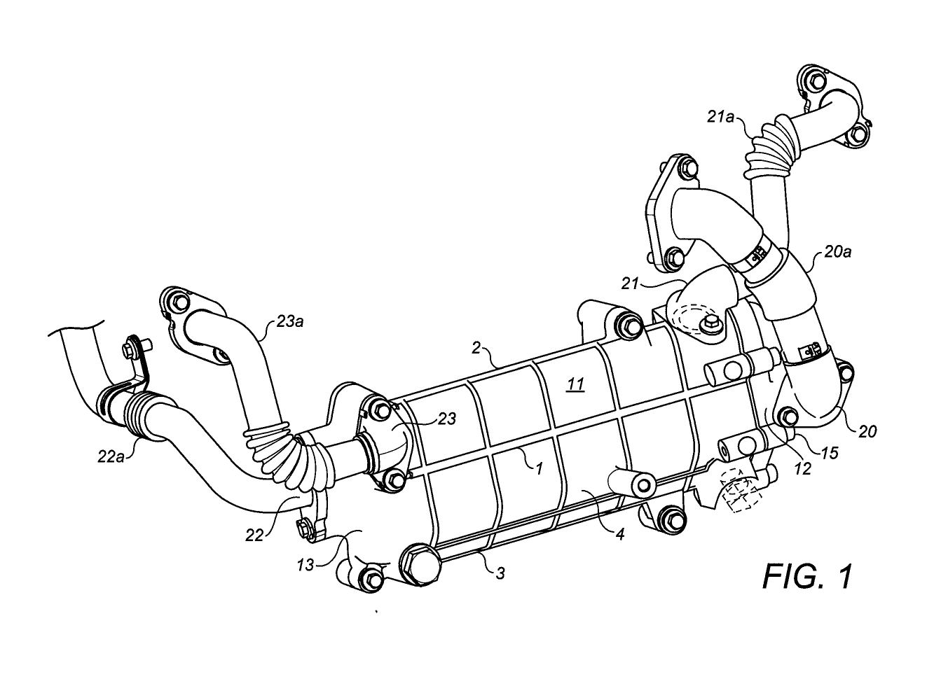

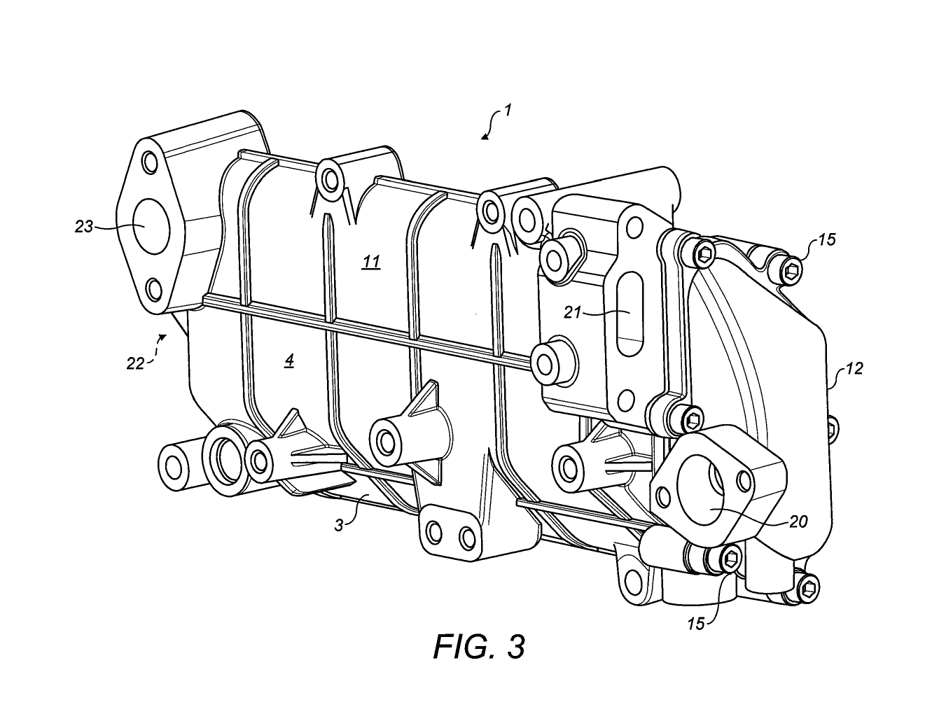

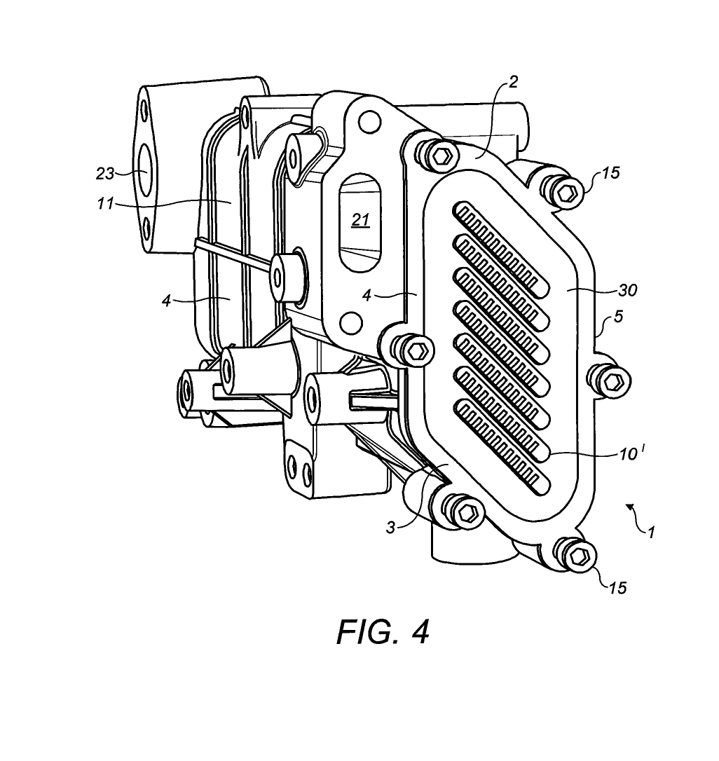

An exhaust gas cooler of the present disclosure is shown in FIGS. 1 to 4 and may comprise a housing 1 having a top wall 2, bottom wall 3, first side wall 4 and second side wall 5. As best shown in FIG. 4, the side walls 4, 5 may be substantially vertical (in the orientation of the cooler as illustrated—which can of course vary depending on the orientation of the exhaust gas cooler itself) and parallel with one another. The top wall 2 and the bottom wall 3 may be parallel to one another and may be canted at an angle of 45 degrees relative to the side walls 4, 5. As such the cross-section of the housing 1 may adopt a generally rhomboid shape.

The housing 1 may comprise a main casing 11 and an end cap 12 at one end. The end cap 12 is fastened to the end of the main casing possibly using bolts 15.

The housing 1 may be provided with an exhaust gas inlet 20, an exhaust gas outlet 22, a coolant inlet 23 and a coolant outlet 21. In use, ancillary pipes may be used to connect the inlets and outlets to an internal combustion engine. FIG. 1 shows an external perspective view of the cooler with the ancillary pipes attached. A gas inlet pipe 20a may be connected to the exhaust gas inlet 20. A gas outlet pipe 22a may be connected to the exhaust gas outlet 22. A coolant inlet pipe 23a may be connected to the coolant inlet 23. A coolant outlet pipe 21a may be connected to the coolant outlet 21.

The coolant inlet 23 and coolant outlet 21 may communicate with a void space within the main casing 11.

In one embodiment seven cooler tubes 10′ may be located within the housing 1 as best shown in FIG. 4 where the ends of the cooler tubes 10′ can be seen protruding through apertures 10 in a first baffle 30. The cooler tubes 10′ may be mounted, by welding, to the first baffle 30. The cooler tubes 10′ may extend along the longitudinal axis of the housing 1 to the second end. One or more intermediate baffles may be provided along the longitudinal length of the cooler tubes to provide structural support. A further baffle may be provided at the second end.

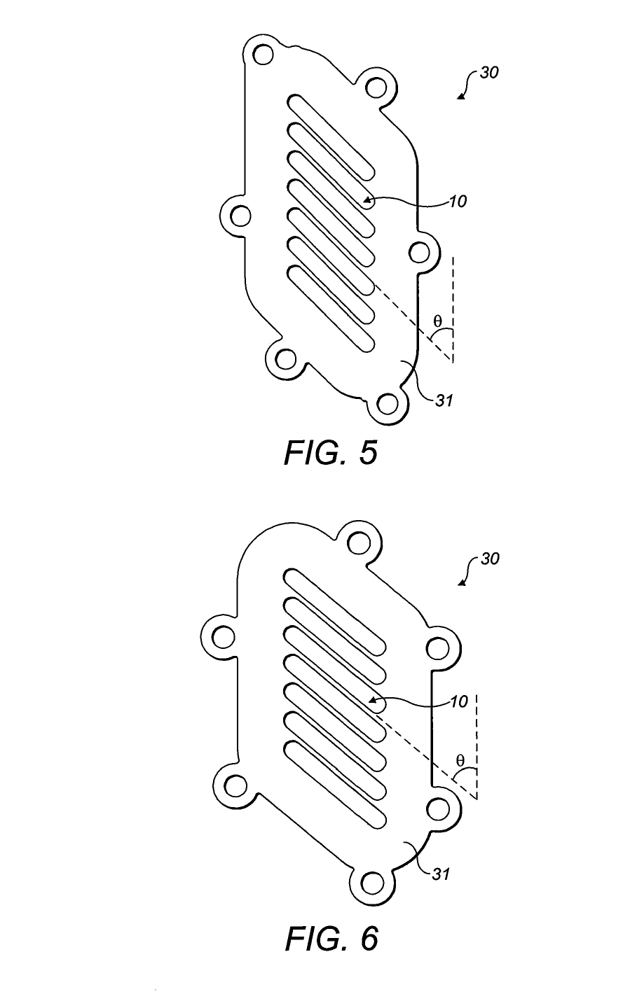

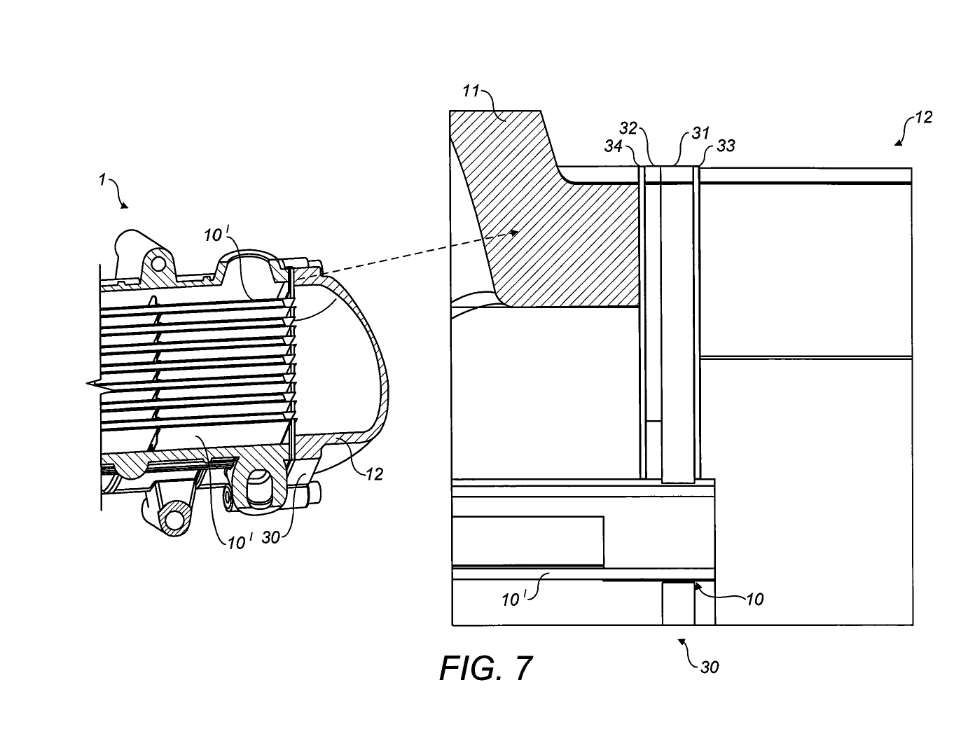

The first baffle 30 is shown in FIG. 5 and a portion of the first baffle 30 is illustrated in cross-section in FIG. 7. The baffle 30 may comprise a baffle plate 31 having a plurality of apertures 10 therein, a reinforcement piece 32, an outer gasket 33 and an inner gasket 34. On assembly, the first baffle 30 may be mounted between the first end of the main casing 11 and the end cap 12 so as to sandwich the baffle plate 31 and reinforcing piece 32 between the gaskets 33, 34.

The cooler tubes 10′ may be welded to the baffle 30 so as to pass through the apertures 10 as shown in FIG. 7. Thus, when assembled an interior of the cooler tubes 10′ is in fluid communication with the interior of end cap 12 which is in turn in fluid communication with the exhaust gas inlet 20 since the ends of the cooler tubes 10′ are open. Similarly at the second end, the exhaust gas outlet 22 may be in fluid communication with the cooler tubes 10′ via an interior of housing end 13.

The coolant inlet 23 and outlet 21 may be connected to the void space within the main casing 11 through which the cooler tubes 10′ extend.

Thus, in use, hot exhaust gases can be blown through the cooler from the exhaust gas inlet 20 to the exhaust gas outlet 22 via the cooler tubes 10′ and at the same time be cooled by pumping a coolant fluid (typically water) through the cooler from the coolant inlet 23 to the coolant outlet 21.

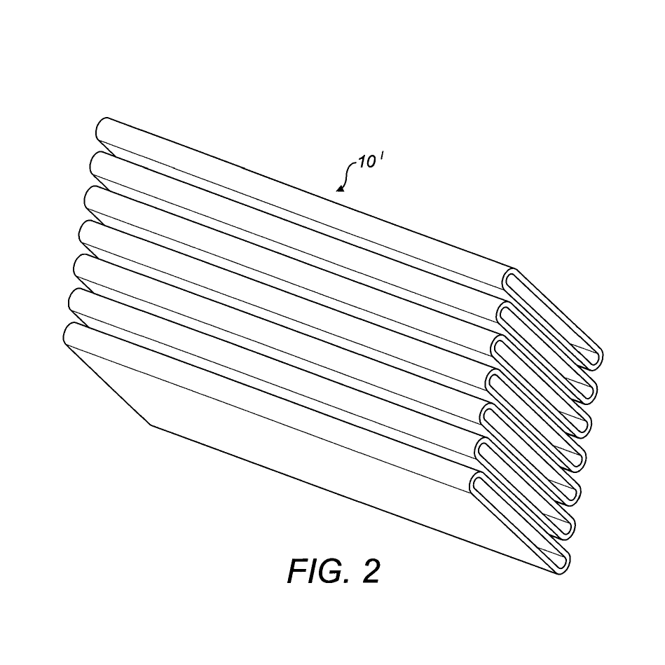

According to the present disclosure, and as shown in FIG. 2, each cooler tube 10′ may have a planar or plank-like shape being generally flat and elongate in a longitudinal direction and having a cross section that is relatively thin compared to the width of the cooler tube 10′. The longitudinal edges of the tubes 10′ may be rounded. The tubes 10′ may be hollow or may contain an arrangement of webs, fins or similar to form a tortuous fluid path through the tube 10′ which serves to increase the effective surface area of the tube to improve heat transfer between the exhaust gas and the coolant fluid.

The plane of each of the cooler tubes 10′ may be canted relative to the side walls 4, 5 at an angle θ of 30 to 80 degrees. In the example of FIG. 5 the canting angle θ is 45 degrees. Thus, the longitudinal edges of each tube 10′ are not level with one another. In addition, as noted previously, the top wall 2 and bottom wall 3 may be canted or angled relative to the side walls 4, 5 such that the cross-sectional shape of the main casing 11 is generally rhomboid. Further the angling of the cooler tubes 10′ may be such that the tubes 10′ run parallel to the top wall 2 and bottom wall 3 along their length. This canting can be seen for example in FIGS. 2 and 4.

FIG. 6 illustrates a baffle 30 of a modified design for use in an exhaust gas cooler according to the present disclosure wherein the angle θ of the apertures 10 which receive the cooler tubes is 50 degrees. (It will be understood that consequently the cooler tubes will also therefore be angled at 50 degrees). Again the top wall 2 and bottom wall 3 are also canted at 50 degrees so that they run parallel to the cooler tubes.

The cooler tubes 10′ may be arranged in a single column equispaced within the housing 1.

Arranging the cooler tubes 10′ in a manner according to the present disclosure has been found to lead to a significantly reduced stress pattern with lower peak von-Mises stresses.

### INDUSTRIAL APPLICABILITY

The present disclosure finds application in exhaust gas coolers for internal combustion engines and leads to improvements in the reliability and durability of such exhaust gas coolers.

### REFERENCE NUMERALS

1 Housing
2 Top wall
3 Bottom wall
4 First side wall
5 Second side wall
10 Apertures
10′ Cooler tubes
11 Main casing
12 End cap
13 Housing end
15 Bolts
20 Exhaust gas inlet
20a Gas inlet pipe
21 Coolant outlet
21a Coolant outlet pipe
22 Exhaust gas outlet
22a Gas outlet pipe
23 Coolant inlet
23a Coolant inlet pipe
30 First baffle
31 Baffle plate
32 Reinforcement piece
33 Outer gasket
34 Inner gasket
θ Canting angle of cooler tubes

1. An exhaust gas cooler comprising:
a housing comprising a top wall, a bottom wall and first and second side walls extending longitudinally from a first end to a second end to define a void space; and
a plurality of cooler tubes extending longitudinally in said housing and arranged in a column from towards the bottom wall to towards the top wall, wherein a plane of each cooler tube is canted relative to the first and second side walls of the housing.

2. An exhaust gas cooler as claimed in claim 1 wherein each cooler tube is substantially planar.

3. An exhaust gas cooler as claimed in claim 1 wherein each cooler tube comprises a first longitudinal edge, a second longitudinal edge and an elongate cross-section.

4. An exhaust gas cooler as claimed in claim 1 wherein the planes of each cooler tube are parallel to each other.

5. An exhaust gas cooler as claimed in claim 1 wherein the plane of each cooler tube is at least one of parallel to a plane of the top wall and parallel to a plane of the bottom wall.

6. An exhaust gas cooler as claimed in claim 1 wherein the housing further comprising:
i) an exhaust gas inlet at or near the first end of the housing and an exhaust gas outlet at or near the second end of the housing; the exhaust gas inlet and the exhaust gas outlet in fluid communication with the plurality of cooler tubes; and
ii) a coolant outlet at or near the first end of the housing and a coolant inlet at or near the second end of the housing; the coolant outlet and the coolant inlet in fluid communication with the void space.

7. An exhaust gas cooler as claimed in claim 1 wherein the plurality of cooler tubes extend longitudinally within the void space parallel to a longitudinal axis of the housing.

8. An exhaust gas cooler as claimed in claim 1 wherein the plurality of cooler tubes are arranged in a single column.

9. An exhaust gas cooler as claimed in claim 1 wherein the plurality of cooler tubes each extend transversely from at or near the first side wall to at or near the second side wall.

10. An exhaust gas cooler as claimed in claim 1 comprising seven cooler tubes.

11. An exhaust gas cooler as claimed in claim 1 wherein the top wall, the bottom wall and the first and second side walls define a rhomboid cross-sectional shape of the housing.

12. An exhaust gas cooler as claimed in claim 1 further comprising one or more baffles arranged transverse to the plurality of cooler tubes.

13. An exhaust gas cooler as claimed in claim 12 wherein one or more of said baffles comprise a baffle plate, one or more reinforcement pieces and one or more gaskets.

14. An exhaust gas cooler comprising:
a housing comprising a top wall, a bottom wall, and first and second side walls extending longitudinally from a first end to a second end to define a void space;
a plurality of cooler tubes extending longitudinally in said housing and arranged in a column from towards the bottom wall to towards the top wall, wherein a plane of each cooler tube is canted relative to the first and second side walls of the housing;
an exhaust gas inlet at or near the first end of the housing and an exhaust gas outlet at or near the second end of the housing, the exhaust gas inlet and the exhaust gas outlet in fluid communication with the plurality of cooler tubes; and
a coolant outlet at or near the first end of the housing and a coolant inlet at or near the second end of the housing, the coolant outlet and the coolant inlet in fluid communication with the void space.

15. The exhaust gas cooler of claim 14, wherein each cooler tube is substantially planar.

16. The exhaust gas cooler of claim 14, wherein each cooler tube comprises a first longitudinal edge, a second longitudinal edge and an elongate cross-section.

17. The exhaust gas cooler of claim 14, wherein the planes of each cooler tube are parallel to each other.

18. The exhaust gas cooler of claim 14, wherein the plane of each cooler tube is at least one of parallel to a plane of the top wall and parallel to a plane of the bottom wall.

19. An exhaust gas cooler comprising:
a housing comprising a top wall, a bottom wall, and first and second side walls extending longitudinally from a first end to a second end to define a void space;
a plurality of cooler tubes extending longitudinally in said housing and arranged in a column from towards the bottom wall to towards the top wall, wherein a plane of each cooler tube is canted relative to the first and second side walls of the housing;
an exhaust gas inlet at or near the first end of the housing and an exhaust gas outlet at or near the second end of the housing, the exhaust gas inlet and the exhaust gas outlet in fluid communication with the plurality of cooler tubes;
a coolant outlet at or near the first end of the housing and a coolant inlet at or near the second end of the housing, the coolant outlet and the coolant inlet in fluid communication with the void space; and
one or more baffles arranged transverse to the plurality of cooler tubes.

20. The exhaust gas cooler of claim 19, wherein one or more of said baffles includes a baffle plate, one or more reinforcement pieces, and one or more gaskets.
